(19) United States
(12) Patent Application Publication
(10) Pub. No.: US 2023/0104534 A1
(43) Pub. Date: Apr. 6, 2023

(54) METHOD OF APPLYING HEAT SHIELD MATERIAL TO PISTON

(71) Applicant: Mazda Motor Corporation, Aki-gun (JP)

(72) Inventors: Masaya Minato, Aki-gun (JP); Ken Sakamoto, Aki-gun (JP); Chiaki Asano, Aki-gun (JP); Tsutomu Shigenaga, Aki-gun (JP)

(21) Appl. No.: 17/900,752

(22) Filed: Aug. 31, 2022

(30) Foreign Application Priority Data
Sep. 28, 2021 (JP) 2021-158210

(51) Int. Cl. B05D 1/32; B05D 1/02; B05D 3/04; F02F 3/12

(52) U.S. Cl. CPC B05D 1/32; B05D 1/02; B05D 3/0406; F02F 3/12

(57) ABSTRACT

A method of applying to a crown surface of a piston, a heat shield material for forming a heat shield layer, is provided. The method includes masking the piston with a masking member, the masking member including a first part that covers at least part of a side surface of the piston with a first clearance between the side surface and the first part, and a second part that covers an outer circumferential part of the crown surface with a second clearance between the outer circumferential part and the second part, and applying the heat shield material, while the piston is masked.

### TECHNICAL FIELD

The present disclosure relates to a method of applying a heat shield material to a piston.

### BACKGROUND OF THE DISCLOSURE

It is generally known that a heat shield layer is provided to a wall surface which forms a combustion chamber of an engine (a crown surface of a piston, a lower surface of a cylinder head, etc.) to reduce cooling loss of the engine and improve fuel efficiency. For example, JP2013-177693A discloses a method of forming a heat shield layer by applying a liquid heat shield material which is a mixture of hollow particles and a binder to the crown surface of the piston by using a spray gun, and calcinating the heat shield layer.

However, in general spray painting, since the overspray amount which is an amount of the heat shield material dispersed on the wall surface other than the crown surface of the piston increases, a problem of a low application efficiency is caused. In consideration of the expensive paint cost, a development of an application method capable of improving application efficiency is desired in order to suppress the manufacturing cost of the piston.

### SUMMARY OF THE DISCLOSURE

One purpose of the present disclosure is to improve application efficiency in application of a heat shield material to a crown surface of a piston.

According to one aspect of the present disclosure, a method of applying to a crown surface of a piston, a heat shield material for forming a heat shield layer is provided. The method includes masking the piston with a masking member, the masking member including a first part that covers at least a part of a side surface of the piston with a first clearance between the side surface and the first part, and a second part that covers an outer circumferential part of the crown surface with a second clearance between the outer circumferential part and the second part, and applying the heat shield material, while the piston is masked.

According to this configuration, an amount of the heat shield material which adheres to a wall surface of the piston other than the crown surface can be reduced, and thus, the application efficiency of the heat shield material to the crown surface improves. Further, the heat shield layer formed on the outer circumferential part in the crown surface of the piston has little contribution to the reduction in cooling loss of the engine and the improvement in fuel efficiency, and therefore, the amount of the heat shield material applied to the outer circumferential part can be suitably reduced, thereby realizing suitable application of the heat shield material.

The applying the heat shield material may be performed while blowing off air from a skirt part side of the piston to the crown surface side via the first clearance and the second clearance.

When spray dust due to overspray of the heat shield material adheres to the side surface of the piston, it damages a cylinder bore surface as the piston reciprocates, thereby causing fuel efficiency deterioration due to compression leakage. According to this configuration, by the blowoff of the air, the adhesion of the heat shield material to the side surface of the piston can be effectively suppressed.

A flow velocity of the air at an exit of the second clearance may be faster than 0.03 m/s and slower than 0.69 m/s.

By regulating the flow velocity of the air at the exit of the second clearance within the range described above, a high application efficiency to the crown surface can be secured, while effectively reducing the adhesion amount of spray dust to the side surface of the piston.

A flow velocity of the air at an air blow-off opening may be faster than 0.1 m/s and slower than 4 m/s.

By regulating the flow velocity of the air at the air blow-off opening within the range described above, the high application efficiency to the crown surface can be secured, while effectively reducing the adhesion amount of spray dust to the side surface of the piston.

The masking member may include a cylindrical accommodating member that accommodates the piston inside, and a ring-shape lid member that is connected to the accommodating member so as to cover one end of the accommodating member in the axial direction, an inner diameter of the lid member being smaller than an inner diameter of the one end. The first part may be comprised of part of the accommodating member on the one end side. The second part may be comprised of an inner circumferential part of the lid member.

According to this configuration, the adhesion amount of spray dust to the wall surface of the piston other than the crown surface can be reduced by adopting a simple configuration.

A radial width of the inner circumferential part of the lid member may be 0.5 mm or more and 5 mm or less.

According to this configuration, the applied amount of the heat shield material to the outer circumferential part can be reduced, while fully securing the applied amount of the heat shield material to the crown surface of the piston.

The applying the heat shield material may include applying the heat shield material to the crown surface, while fixing a paint spray gun disposed on the crown surface side of the piston, and moving the piston.

According to this configuration, by fixing the paint spray gun, the straightness of the droplet which is sprayed from the paint spray gun can be secured. Thus, by moving the piston, the adhesion of spray dust to the wall surface of the piston other than the crown surface can be suppressed, and application efficiency of the heat shield material to the crown surface can be improved.

The applying the heat shield material to the crown surface may be performed by the paint spray gun. A relative position of the paint spray gun with respect to the piston may be maintained inward of an outer circumferential end of the crown surface.

According to this configuration, since the relative position of the paint spray gun with respect to the piston is maintained inward of the outer circumferential end of the crown surface, the paint spray gun being located outward of the crown surface can be suppressed, and therefore, the overspray of the heat shield material is suppressed.

The second clearance may be larger than the first clearance.

Since the second clearance is larger than the first clearance, the adhesion of spray dust to the side surface of the piston can be suppressed effectively, while suitably securing the applied amount of the heat shield material to the outer circumferential part of the piston crown surface.

The first clearance may be 0.1 mm or more and 0.5 mm or less.

By setting the first clearance within the range described above, the adhesion of spray dust to the side surface of the piston can be suppressed effectively.

The second clearance may be 0.3 mm or more and 1.0 mm or less.

By setting the second clearance within the range described above, the heat shield layer at the outer circumferential part of the piston crown surface can be formed appropriately, while securing the high application efficiency to the crown surface.

### BRIEF DESCRIPTION OF DRAWINGS

FIG. 1 is a view illustrating one example of a configuration of an application device of a heat shield material of a piston.

FIG. 2 is a plan view of the device in FIG. 1.

FIG. 3 is a view illustrating one example of the configuration of the heat shield material application device of the piston.

FIG. 4 is a view illustrating a process of a method of applying heat shield material to the piston according to one embodiment.

FIG. 5 is a view illustrating a locus A of a relative position of a paint spray gun with respect to the piston.

FIG. 6 is a view illustrating a locus B of the relative position of the paint spray gun with respect to the piston.

FIG. 7 is a graph illustrating adhesion amounts of heat shield material on a piston side surface in Examples 1-4 and Comparative Examples 1-3.

### DETAILED DESCRIPTION OF THE DISCLOSURE

Hereinafter, one embodiment for implementing the present disclosure is described with reference to the accompanying drawings. The following description of the desirable embodiment is merely illustration essentially, and it is not intended to limit the present disclosure, its application, or its use.

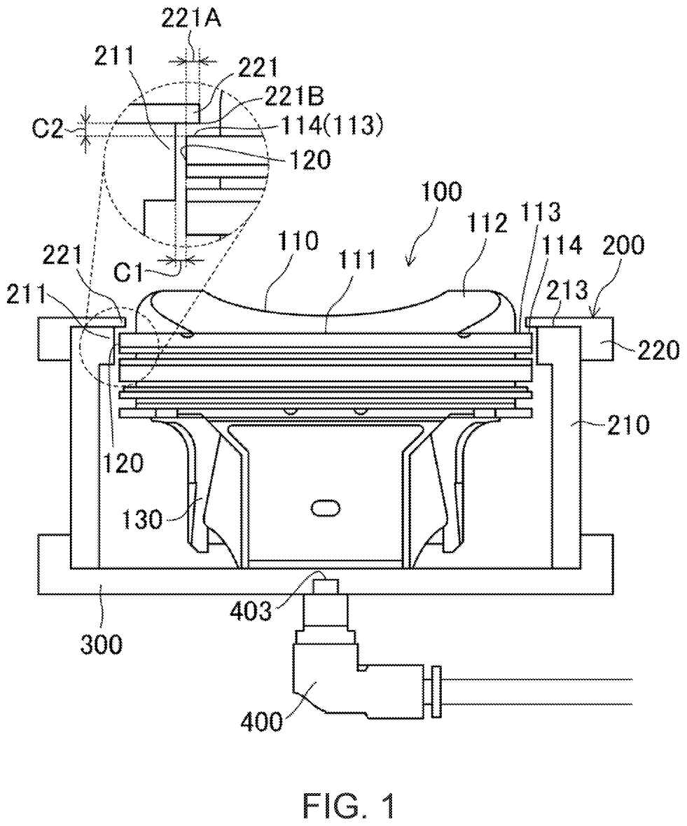

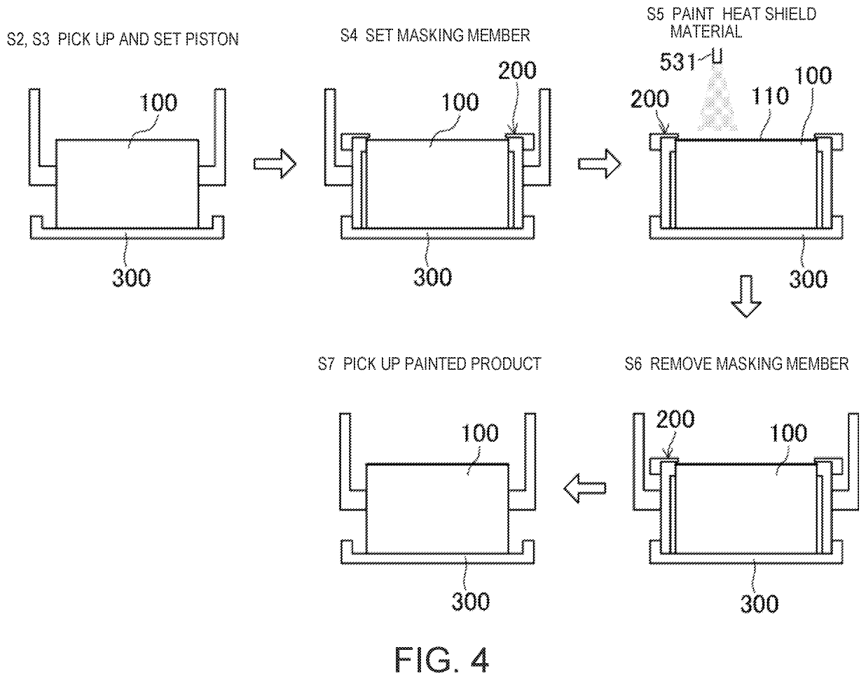

A method of applying a heat shield material to a piston according to one embodiment of present the disclosure is a method of applying the heat shield material for forming a heat shield layer on a crown surface of the piston. FIGS. 1 to 3 are views illustrating one example of a configuration of a heat shield material application device for implementing the method of applying the heat shield material. FIG. 4 is a view illustrating a process of the method of applying the heat shield material. Note that although FIGS. 1, 2, and 4 may include a partial cross section, hatching is omitted for simplification.

<Piston>

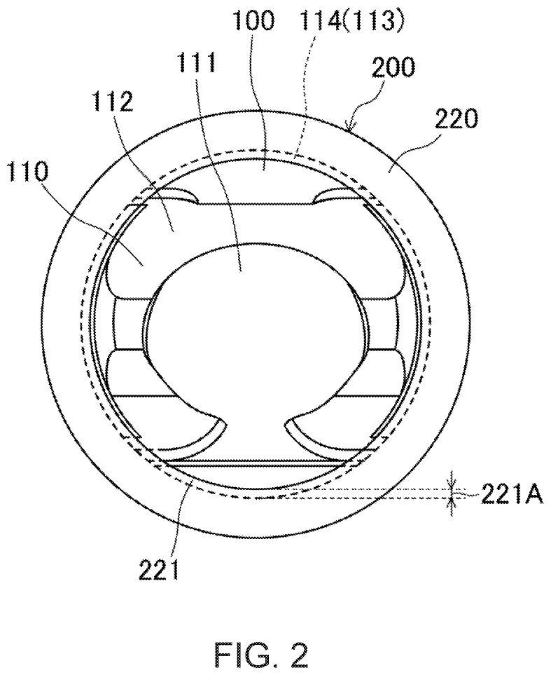

As illustrated in FIGS. 1 and 2, a piston 100 includes a crown surface 110, a side surface 120, and a skirt part 130. The crown surface 110 is provided with a cavity 111 in a center part, and a bulged part 112 is formed around the cavity 111. An annular flat part 113 is formed outside the bulged part 112. Note that an outer circumferential part 114 of the annular flat part 113 corresponds to an outer circumferential part of the crown surface 110 including an outer circumferential end of the crown surface 110.

The piston 100 is, for example, made of aluminum alloy, and it is inserted in a cylinder bore (not illustrated) of a cylinder block (not illustrated) of an engine. A combustion chamber of the engine is formed by the crown surface 110 of the piston 100, an inner circumferential surface of the cylinder bore, a cylinder head (not illustrated), and front surfaces (surfaces facing the combustion chamber) of umbrella parts of intake and exhaust valves (not illustrated) which open and close intake and exhaust ports (not illustrated) of the cylinder head.

The shape, etc. of the piston 100 is merely an example, which may suitably be changed according to the configuration, etc. of the engine. Note that the engine may be a gasoline engine or a diesel engine.

Heat Shield Layer

A heat shield layer formed on the crown surface 110 of the piston 100 is not limited, as long as it can be formed by a method of forming a heat shield layer which will be described later. In detail, for example, the heat shield layer may be provided with a large number of hollow particles made of inorganic oxide or ceramics, and resin binder which fixes the hollow particles to the crown surface 110 and fills between the hollow particles to form a base material (matrix) of the heat shield layer. Nanoparticles may be dispersed in the resin binder.

The thickness of a heat shield layer may be, for example, 20 μm or more and 150 μm or less, and preferably 30 μm or more and 100 μm or less, and more preferably 50 μm or more and 70 μm or less. As hollow particles, those having a particle diameter of μm order which is smaller than the thickness of the heat shield layer may be used. The average particle diameter may preferably be 30 μm or less, for example. For example, hollow particles having the average particle diameter of 10 μm or less, preferably 3 μm or more and 5 μm or less may be adopted. The average particle diameter of nanoparticles may preferably be 500 nm or less, more preferably be 1 nm or more and 200 nm or less, and more preferably be 1 nm or more and 120 nm or less. Note that the numerical value ranges described above are desirable ranges, and are not considered to be restrictive.

As the hollow particles, inorganic hollow particles may be adopted, and, for example, ceramic-based hollow particles containing Si-based oxide components (e.g., silica) or aluminum-based oxide component (e.g., alumina), such as glass balloons, glass bubbles, fly ash balloons, Shirasu balloons, silica balloons, and aluminosilicate balloons, may preferably be adopted. A hollow ratio of the hollow particles may preferably be 60% by volume or higher, and more preferably 70% by volume or higher.

As a resin binder, for example, silicone-based resin made of three-dimensional polymer with a high degree of branch which is represented by methyl silicone-based resin and methylphenyl silicone-based resin may preferably be used. One concrete example of the silicone-based resin is polyalkylphenylsiloxane, for example.

As the nanoparticles, inorganic nanoparticles made of inorganic compounds, such as zirconia, alumina, silica, and titania, or metal nanoparticles, such as Ti, and Zr, and Al, may be adopted, and particularly, silica nanoparticles modified by phenyl group on the surface may preferably be adopted. The nanoparticles may be hollow or solid.

The blending quantity of the nanoparticles (a ratio of the nanoparticles with respect to the total amount of the resin binder and the nanoparticles after the heat shield layer is calcinated) may preferably be 10% by volume or higher and 55% by volume or lower. The blending quantity of the hollow particles (a ratio of the hollow particles contained in the heat shield layer after the calcination) may be adjusted according to the thermal insulation performance required for the heat shield layer. The blending quantity of the hollow particles may be 30% by volume or higher and 60% by volume or lower, for example. The blending quantity may more preferably be 40% by volume or higher and 55% by volume or lower.

Method of Forming Heat Shield Layer

The heat shield layer is formed by preparing a liquid heat shield material, applying the heat shield material to the crown surface 110 of the piston 100, and drying and calcinating the heat shield material. The heat shield material contains, for example, the hollow particles, the resin binder, and nanoparticles and solvent, if needed. Upon manufacturing such a heat shield material, reactant silicone-based resin solution for the binders is first obtained by adding solvent, such as toluene, to a raw resin solution. The nanoparticles are added to the reactant silicone-based resin solution and stirred, if needed, and the hollow particles are further added and stirred, to obtain the liquid heat shield material for being applied to the crown surface 110 of the piston 100. The calcination after the application of the heat shield material can be performed by heating the piston 100 to which the heat shield material is applied at a temperature of about 100-200° C. for several minutes to several hours.

Note that the details of the method of applying the heat shield material to the crown surface 110 will be described later.

<Heat Shield Material Application Device and Application Method>

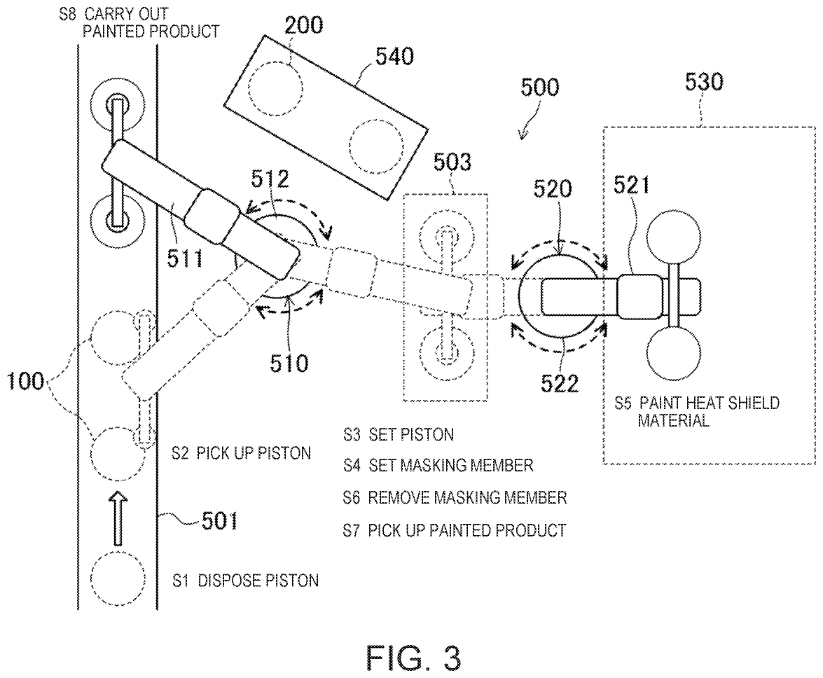

As illustrated in FIGS. 3 and 4, a heat shield material application device 500 includes a conveyor 501, a first robot 510, a second robot 520, a painting booth 530, and a temporary placing table 540.

The piston 100 supplied by the conveyor 501 is disposed (S1) to a pick-up position, where it is picked up by a first robotic arm 511 of the first robot 510 (S2). The first robotic arm 511 rotates on an axis of a first base 512 of the first robot 510, perpendicular to the drawing sheet of FIG. 3, and sets the piston 100 onto a table 300 (see FIG. 4) of a piston set position 503 (S3). Then, the first robot 510 picks up, by the first robotic arm 511, a masking member 200 disposed at the temporary placing table 540. Then, the piston 100 disposed at the piston set position 503 is covered with the masking member 200 from above. Thus, the piston 100 becomes in a state where it is masked with the masking member 200 (S4).

Next, a second robotic arm 521 of the second robot 520 supports the masked piston 100. The second robotic arm 521 rotates on an axis of a second base 522 of the second robot 520, perpendicular to the drawing sheet of FIG. 3, and sets the masked piston 100 at a paint position of the painting booth 530. Then, by using a paint spray gun 531 (see FIG. 4) disposed on the crown surface 110 side, spray painting of the heat shield material is carried out to the crown surface 110 of the masked piston 100 (S5).

When the application of the heat shield material is finished, the second robotic arm 521 rotates on the axis of the second base 522, and returns the piston 100, where the masking member 200 is set, to the piston set position 503. Thus, the masking member 200 is removed from the piston 100 by the first robotic arm 511 (S6), and the masking member 200 is returned to the temporary placing table 540. Then, the first robotic arm 511 picks up the piston 100 where the heat shield material has been painted (hereinafter, referred to as the “painted product”) (S7), and disposes it on the conveyor 501. Then, the painted product is carried out by the conveyor 501 (S8). The carried-out painted product will become a final product through a process, such as calcination, as described above.

Masking Member

As illustrated in FIGS. 1 and 2, the masking member 200 includes a cylindrical accommodating member 210 and a ring-shaped lid member 220.

The accommodating member 210 accommodates the piston 100 therein. A first part 211 of the accommodating member 210 is comprised of a part of the accommodating member 210 on one axial end 213 side, and it covers at least a part of the side surface 120 of the piston 100 with a first clearance C1 between the first part 211 and the side surface 120. In detail, the inner circumferential surface of the first part 211 covers a part of the side surface 120 on the crown surface 110 side over the entire circumference of the side surface 120. Note that the inner circumferential surface of the first part 211 may cover the entire side surface 120.

The lid member 220 is connected to the accommodating member 210 so as to cover the one end 213 of the accommodating member 210. An inner diameter of the lid member 220 is smaller than an inner diameter of the one end 213. A second part 221 comprised of an inner circumferential part of the lid member 220 covers the outer circumferential part 114 with a second clearance C2 between the second part 221 and the outer circumferential part 114.

By applying the heat shield material where the piston 100 is masked by such a masking member 200, since the amount of the heat shield material which adheres to the wall surface of the piston 100 other than the crown surface 110 is reduced, the application efficiency of the heat shield material to the crown surface 110 can be improved. Further, since the heat shield layer formed on the outer circumferential part 114 has little contribution to the reduction in cooling loss of the engine and the improvement in fuel efficiency, the applied amount of the heat shield material to the outer circumferential part 114 can be suitably reduced, thereby realizing suitable application of the heat shield material.

Note that a radial width 221A of the second part 221 of the lid member 220 may preferably be 0.5 mm or more and 5 mm or less, in order to fully secure the applied amount of the heat shield material to the crown surface 110, and reducing the applied amount of the heat shield material to the outer circumferential part 114. Further, in the piston 100 illustrated in FIG. 1, the width 221A may preferably be 5 mm or less, in order for the second part 221 not to contact the bulged part 112.

Moreover, the second clearance C2 may preferably be larger than the first clearance C1. Therefore, the adhesion of spray dust to the side surface 120 can be suppressed effectively, while suitably securing the applied amount of the heat shield material to the outer circumferential part 114.

Note that the first clearance C1 may preferably be 0.1 mm or more and 0.5 mm or less. If the first clearance C1 is below the lower limit, the masking member 200 may contact the side surface 120. Further, as will be described later, upon performing the blowoff of air from an air mechanism 400, the blowoff speed and the blowoff amount of air to the crown surface 110 side may decrease excessively if the first clearance C1 is below the lower limit. On the other hand, when the first clearance C1 exceeds the upper limit, the adhesion amount of spray dust to the side surface 120 may increase. By using the first clearance C1 as the range described above, the adhesion of spray dust to the side surface 120 can be suppressed effectively.

Further, the second clearance may preferably be 0.3 mm or more and 1.0 mm or less. If the second clearance C2 is below the lower limit, the second part 221 of the lid member 220 may contact the surface of the coated film of the heat shield material which is formed by the heat shield material infiltrating into the second clearance C2, thereby disturbing this surface. If the second clearance C2 exceeds the upper limit, the infiltrating amount of the heat shield material into the second clearance C2 increases, and a decrease in application efficiency to the crown surface 110 may be caused. By using the second clearance C2 as the range described above, the heat shield layer of the outer circumferential part 114 can be formed appropriately, while securing the high application efficiency to the crown surface 110.

Note that the numerical value ranges described above are desirable ranges, and therefore, they are not restrictive.

Note that the accommodating member 210 and the lid member 220 may be formed integrally or separately. The material of the masking member is not limited in particular, and may be a common material, such as metal, resin, etc.

Air Mechanism

As illustrated in FIG. 1, at step S5 for painting the heat shield material, the heat shield material may be applied, while blowing off the air from the skirt part 130 side of the piston 100 to the crown surface 110 side via the first clearance C1 and the second clearance C2, by the air mechanism 400 disposed on the table 300.

When the spray dust due to the overspray of the heat shield material adheres to the side surface 120 of the piston 100, it damages the cylinder bore surface (not illustrated) as the piston 100 reciprocates, thereby causing fuel efficiency deterioration due to compression leakage. By the blowoff of the air, it can effectively reduce the adhesion amount of spray dust of the heat shield material to the side surface 120 of the piston 100.

Note that although it is not intended to limit, the flow velocity of the air discharged from an exit 221B of the second clearance C2 may preferably be faster than 0.03 m/s and slower than 0.69 m/s, more preferably be 0.04 m/s or faster and 0.52 m/s or slower, still more preferably be 0.05 m/s or faster and 0.40 m/s or slower, and particularly preferably be 0.09 m/s or faster and 0.35 m/s or slower.

If the flow velocity of the air discharged from the exit 221B of the second clearance C2 is 0.03 m/s or slower, the adhesion amount of spray dust to the side surface 120 may increase. Further, if the flow velocity of the air discharged from the exit 221B is 0.69 m/s or faster, the floating amount of the heat shield material may increase to lower application efficiency to the crown surface 110. By regulating the flow velocity of the air at the exit 221B within the range described above, the high application efficiency to the crown surface 110 can be secured, while effectively reducing the adhesion amount of spray dust to the side surface 120.

Further, although it is not intended to limit, the flow velocity of the air discharged from a blow-off opening 403 of the air mechanism 400 may preferably be faster than 0.1 m/s and slower than 4 m/s, more preferably be 0.2 m/s or faster and 3 m/s or slower, still more preferably be 0.3 m/s or faster and 2 m/s or slower, and particularly preferably be 0.5 m/s or faster and 2 m/s or slower.

If the flow velocity of the air discharged from the blow-off opening 403 is 0.1 m/s or slower, the adhesion amount of spray dust to the side surface 120 may increase. Further, if the flow velocity of the air discharged from the blow-off opening 403 is 4 m/s or faster, the amount and the speed of the air discharged to the crown surface 110 side via the second clearance C2 become large, and therefore, the floating amount of the heat shield material may increase, and application efficiency to the crown surface 110 may decrease. By regulating the flow velocity of the air discharged from the blow-off opening 403 within the range described above, the high application efficiency to the crown surface 110 can be secured, while effectively reducing the adhesion amount of spray dust to the side surface 120.

Relative Position of Paint Spray Gun with Respect to Piston

At step S5 for painting the heat shield material, in order to apply the heat shield material to the entire crown surface 110, a relative position of the paint spray gun 531 with respect to the piston 100 may preferably be changed. As a method of changing the relative position, the paint spray gun 531 may be moved while the piston 100 is fixed, or the piston 100 may be moved while the paint spray gun 531 is fixed. The method of moving the piston 100 while the paint spray gun 531 is fixed is preferred. By fixing the paint spray gun 531, the straightness of the droplet which is sprayed from the paint spray gun 531 can be secured. Thus, by moving the piston 100, the adhesion of spray dust to the wall surface other than the crown surface 110 can be suppressed, and application efficiency of the heat shield material to the crown surface 110 can be improved.

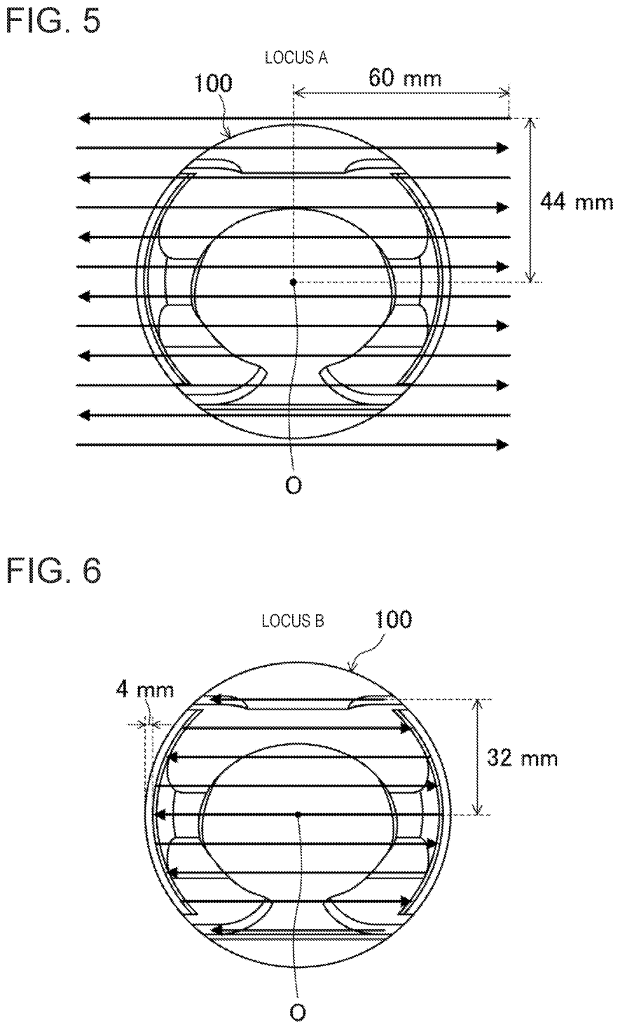

Note that although a moving path (i.e., a locus) of the piston 100 or the paint spray gun 531 is not limited in particular, it may preferably be a locus on which the piston 100 or the paint spray gun 531 linearly and parallelly moves in both directions by a certain line segment distance, in order to efficiently perform the application of the heat shield material to the crown surface 110 (see FIGS. 5 and 6).

Further, the relative position of the paint spray gun 531 with respect to the piston 100 (in other words, the locus described above) may be maintained preferably inward of the outer circumferential end of the crown surface 110, preferably inward of the outer circumferential end of the crown surface 110 by 1 to 5 mm in the radial direction of the crown surface 110. Therefore, the paint spray gun 531 is suppressed from being located outward of the crown surface 110, and therefore, the overspray of the heat shield material is suppressed.

Adhesion Ratio of Heat Shield Material

The application efficiency which is an adhesion ratio of the heat shield material to the crown surface 110 of the piston 100 may preferably be 66% or higher, although this range is not limiting.

Further, the adhesion ratio of the heat shield material to the side surface 120 of the piston 100 may preferably be 0.31% or lower, more preferably be 0.07% or lower, and particularly preferably be 0.05% or lower, although these ranges are not limiting.

### EXAMPLES

Next, examples in which the above embodiment is carried out concretely are described.

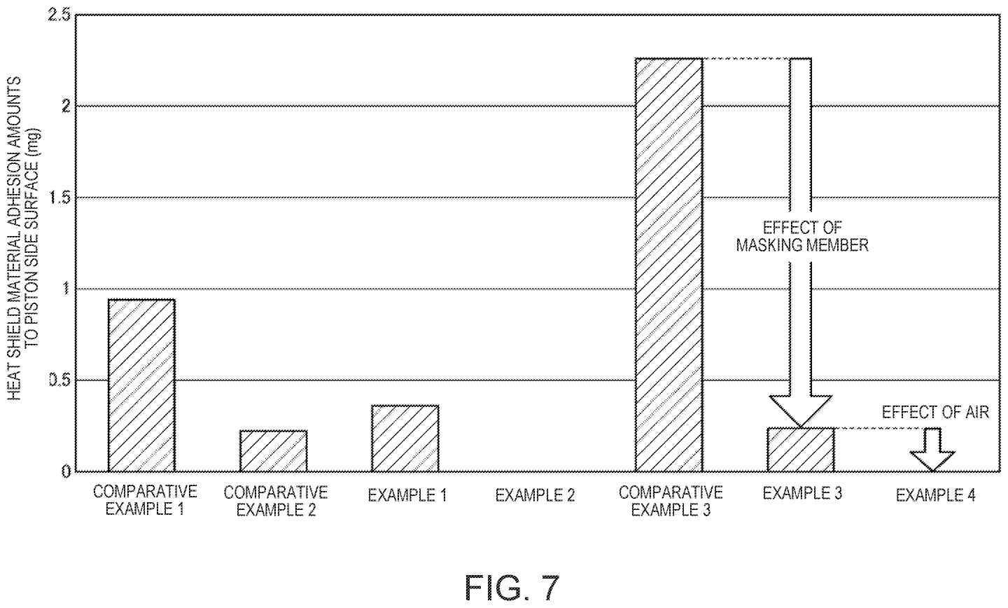

A ratio (%) of the heat shield material adhering to each part or becoming the floating droplet when spraying the heat shield material to the crown surface of the piston is calculated by a computer simulation using a thermal fluid program. Calculation conditions and results of Comparative Examples 1-3 and Examples 1-12 are illustrated in Table 1, FIG. 7, and Table 2.

TABLE 1

| | | | Comparative | | | | Comparative | | |
|---|---|---|---|---|---|---|---|---|---|
| | | | Examples | | Examples | | Examples | Examples | |
| | | | 1 | 2 | 1 | 2 | 3 | 3 | 4 |
| Masking Member | | | Without | Without | With | With | Without | With | With |
| 1st Clearance C1 (mm) | | | — | — | 0.1 | 0.1 | — | 0.1 | 0.1 |
| 2nd Clearance C2 (mm) | | | — | — | 0.5 | 0.5 | — | 0.5 | 0.5 |
| Fixed Member | | | Piston | | | | Spray Gun | | |
| Locus | | | A | B | | | | | |
| Blow-off Opening | | | — | — | — | 0.5 | — | — | 0.5 |
| Air Flow Velocity (m/s) | | | | | | | | | |
| Heat Shield | Piston | Crown | 26.48 | 62.45 | 69.78 | 68.63 | 65.67 | 72.45 | 70.83 |
| Material | | Surface | | | | | | | |
| Ratio (%) | | Side | 0.29 | 0.19 | 0.31 | 0.00 | 1.93 | 0.20 | 0.00 |
| | | Surface | | | | | | | |
| | | Other Wall | 55.57 | 6.49 | 0.00 | 0.00 | 7.79 | 0.00 | 0.00 |
| | | Surfaces | | | | | | | |
| | Masking | Inner Wall | — | — | 0.42 | 0.01 | — | 0.26 | 0.00 |
| | Member | Upper | — | — | 12.37 | 11.25 | — | 12.89 | 12.18 |
| | | Surface | | | | | | | |

| | | | | | | | |
|---|---|---|---|---|---|---|---|
| Floating Droplet | 17.66 | 30.88 | 17.13 | 20.11 | 24.61 | 14.20 | 16.99 |

TABLE 2

| | | | Examples | | | | | | | |
|---|---|---|---|---|---|---|---|---|---|---|
| | | | 5 | 6 | 7 | 8 | 9 | 10 | 11 | 12 |
| Masking Member | | | With | | | | | | | |
| 1st Clearance C1 (mm) | | | 0.1 | | | | 0.3 | 0.5 | 0.1 | 0.1 |
| 2nd Clearance C2 (mm) | | | 0.5 | | | | 0.5 | 0.5 | 0.3 | 1.0 |
| Fixed Member | | | Spray Gun | | | | | | | |
| Locus | | | B | | | | | | | |
| Air Flow | Blow-off Opening | | 0.1 | 0.3 | 2 | 4 | 0.5 | | | |
| Velocity (m/s) | C2 Exit | | 0.03 | 0.05 | 0.34 | 0.69 | 0.23 | 0.35 | 0.13 | 0.06 |
| Heat Shield | Piston | Crown | 80.95 | 78.80 | 66.49 | 65.32 | 75.68 | 66.80 | 69.14 | 69.59 |
| Material | | Surface | | | | | | | | |
| Ratio (%) | | Side | 0.07 | 0.00 | 0.00 | 0.00 | 0.00 | 0.00 | 0.00 | 0.00 |
| | | Surface | | | | | | | | |
| | | Other Wall | 0.00 | 0.00 | 0.00 | 0.00 | 0.00 | 0.00 | 0.00 | 0.00 |
| | | Surfaces | | | | | | | | |
| | Mask | Inner Wall | 0.07 | 0.01 | 0.00 | 0.00 | 0.00 | 0.00 | 0.00 | 0.01 |
| | Member | Upper | 12.89 | 12.09 | 11.23 | 10.53 | 12.27 | 10.37 | 11.21 | 10.65 |
| | | Surface | | | | | | | | |

| | | | | | | | | |
|---|---|---|---|---|---|---|---|---|
| Floating Droplet | 18.98 | 21.20 | 22.28 | 24.14 | 24.32 | 22.83 | 19.65 | 19.75 |

Note that physical properties and spraying conditions of the heat shield material are set as illustrated in Table 3.

TABLE 3

| | | |
|---|---|---|
| Physical | Viscosity Coefficient (Pa · s) | 0.027 |
| Properties | Surface Tension (N/m) | 0.02 |
| | Density (kg/m³) | 930 |
| Spraying | Particle Diameter (μm) | 30 |
| Conditions | Injection Velocity (m/s) | 3.2 |
| | Injection Angle (°) | 14 |

When spraying the heat shield material, the heat shield material was applied to the entire crown surface of the piston by fixing one of the piston and the paint spray gun and moving the other. Note that in Tables 1 and 2, only fixed members are illustrated.

Further, as the locus indicative of the relative position of the paint spray gun with respect to the piston, a locus A illustrated in FIG. 5 and a locus B illustrated in FIG. 6 are used.

In either one of the locus A and the locus B, the relative position linearly and parallelly moves in both directions by a certain line segment distance, as illustrated by arrows in FIGS. 5 and 6. In either one of the loci A and B, the linear velocity which is a moving speed of the relative position is 150 mm/s, and the line segment distance is 8 mm.

The locus A is set so that a width in a direction parallel to the moving direction of the relative position is ±60 mm, where a bore center O of the piston is 0, and a width in a direction perpendicular to the moving direction of the relative position is ±44 mm, where the bore center O of the piston is 0. That is, the locus A is set so that the relative position of the paint spray gun reaches a position beyond the outer circumferential end of the piston crown surface.

The locus B is set so that the width in the direction parallel to the moving direction of the relative position is up to 4 mm inward in the radial direction of the crown surface from the outer circumferential end of the piston crown surface, and the width in the direction perpendicular to the moving direction of the relative position is ±32 mm, where the bore center O of the piston is 0. That is, the locus B is set so that the relative position of the paint spray gun with respect to the piston is maintained inward of the outer circumferential end of the crown surface.

### Comparative Examples 1-3

In Comparative Examples 1-3, the heat shield material was sprayed, without using the masking member.

In the setting of the fixed piston, when comparing Comparative Example 1 of the locus A with Comparative Example 2 of the locus B, the adhesion ratio of the heat shield material to the piston crown surface (i.e., application efficiency) increases from about 26% to about 62%. That is, in order to improve application efficiency, it was found that the locus B is more desirable than the locus A. Therefore, the locus B is adopted in Comparative Example 3 and Examples 1-12.

Next, when comparing Comparative Example 2 of the fixed piston with Comparative Example 3 of the fixed paint spray gun, it was found that the application efficiency to the piston crown surface improved more in the fixed paint spray gun than the fixed piston. Note that although application efficiency to the piston crown surface improved in Comparative Example 3 compared to Comparative Example 2, this also resulted in an increase in the adhesion ratio of the spray dust to the piston side surface.

### Examples 1-4

In Examples 1-4, the heat shield material was sprayed using the masking member.

Application efficiency improved more in Example 1 than Comparative Example 2.

Moreover, as compared with Example 1 of the fixed piston, it was found that in Example 3 of the fixed paint spray gun, application efficiency is further improved and the adhesion amount of spray dust to the piston side surface decreases a little.

Further, in Examples 2 and 4 in which the blowoff of the air by using the air mechanism is performed at the air flow velocity in the blow-off opening of 0.5 m/s, it was found that application efficiency decreases slightly compared with Examples 1 and 3 in which the air mechanism is not used, but the adhesion amount of spray dust to the piston side surface becomes 0.

Note that as illustrated in FIG. 7, with the paint spray gun fixed, when comparing Comparative Example 3 in which the masking member is not used with Example 3 in which the masking member is used, it was found that the adhesion amount of spray dust to the piston side surface decreased significantly because of the existence of the masking member. Further, when comparing Example 3 in which the air mechanism is not used with Example 4 in which the air mechanism is used, it was found that the adhesion amount of spray dust to the piston side surface further decreased because of the use of the air mechanism.

### Examples 5-8

Under the calculation conditions of Example 4, the air flow velocity at the exit of the second clearance C2 and the adhesion ratio of the heat shield material were calculated, while changing the air flow velocity at the blow-off opening in the air mechanism to 0.1 m/s (Example 5), 0.3 m/s (Example 6), 2 m/s (Example 7), and 4 m/s (Example 8).

As illustrated in Example 5, when the air flow velocity at the blow-off opening is reduced to 0.1 m/s, application efficiency to the piston crown surface increased, but the blowoff speed and the blowoff amount of air from the exit of the second clearance were reduced, and therefore, it was seen that the adhesion amount of spray dust to the piston side surface tended to increase.

On the other hand, as illustrated in Example 8, when the air flow velocity at the blow-off opening is increased to 4 m/s, the blowoff speed and the blowoff amount of air from the second clearance increased excessively, which resulted in that the adhesion amount of spray dust to the piston side surface was 0, but the application efficiency to the piston crown surface fell.

### Examples 9-12

Under the calculation conditions of Example 4, the air flow velocity at the exit of the second clearance C2 and the adhesion ratio of the heat shield material were calculated, while the first clearance C1 and the second clearance C2 were adjusted to the values illustrated in Table 2.

In Examples 9 and 10, the second clearance C2 was fixed to 0.5 mm and the first clearance C1 was changed to 0.3 mm and 0.5 mm, respectively, as a result, the high application efficiency of 66% or higher was acquired, and the adhesion amount of spray dust to the piston side surface was 0.

In Examples 11 and 12, the first clearance C1 was fixed to 0.1 mm and the second clearance C2 was changed to 0.3 mm and 1.0 mm, respectively, as a result, the high application efficiency of 66% or higher was acquired, and the adhesion amount of spray dust to the piston side surface was 0.

Since the present disclosure can improve the application efficiency in the application of the heat shield material to the crown surface of the piston, it is very useful.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

100 Piston
110 Crown Surface
114 Outer Circumferential Part
120 Side Surface
130 Skirt Part
200 Masking Member
210 Accommodating Member
211 First Part
220 Lid Member
221 Second Part
221B Exit (of Second Clearance)
400 Air Mechanism
403 Blow-off Opening (of Air Mechanism)
531 Paint Spray Gun
C1 First Clearance
C2 Second Clearance

What is claimed is:

1. A method of applying to a crown surface of a piston, a heat shield material for forming a heat shield layer, comprising the steps of:
masking the piston with a masking member, the masking member including a first part that covers at least part of a side surface of the piston with a first clearance between the side surface and the first part, and a second part that covers an outer circumferential part of the crown surface with a second clearance between the outer circumferential part and the second part; and
applying the heat shield material, while the piston is masked.

2. The method of claim 1, wherein the applying the heat shield material is performed while blowing off air from a skirt part side of the piston toward a crown surface side via the first clearance and the second clearance.

3. The method of claim 2, wherein a flow velocity of the air at an exit of the second clearance is faster than 0.03 m/s and slower than 0.69 m/s.

4. The method of claim 3, wherein a flow velocity of the air at an air blow-off opening is faster than 0.1 m/s and slower than 4 m/s.

5. The method of claim 4,
wherein the masking member includes:
a cylindrical accommodating member that accommodates the piston inside; and
a ring-shape lid member that is connected to the accommodating member so as to cover one end of the accommodating member in the axial direction, an inner diameter of the lid member being smaller than an inner diameter of the one end,
wherein the first part is comprised of part of the accommodating member on the one end side, and
wherein the second part is comprised of an inner circumferential part of the lid member.

6. The method of claim 5, wherein a radial width of the inner circumferential part of the lid member is 0.5 mm or more and 5 mm or less.

7. The method of claim 6, wherein the applying the heat shield material includes applying the heat shield material to the crown surface, while fixing a paint spray gun disposed on the crown surface side of the piston, and moving the piston.

8. The method of claim 7,
wherein the applying the heat shield material to the crown surface is performed by the paint spray gun, and
wherein a relative position of the paint spray gun with respect to the piston is maintained inward of an outer circumferential end of the crown surface.

9. The method of claim 8, wherein the second clearance is larger than the first clearance.

10. The method of claim 9, wherein the first clearance is 0.1 mm or more and 0.5 mm or less.

11. The method claim 10, wherein the second clearance is 0.3 mm or more and 1.0 mm or less.

12. The method of claim 2, wherein a flow velocity of the air at an air blow-off opening is faster than 0.1 m/s and slower than 4 m/s.

13. The method of claim 1,
wherein the masking member includes:
a cylindrical accommodating member that accommodates the piston inside; and
a ring-shape lid member that is connected to the accommodating member so as to cover one end of the accommodating member in the axial direction, an inner diameter of the lid member being smaller than an inner diameter of the one end,
wherein the first part is comprised of a part of the accommodating member on the one end side, and
wherein the second part is comprised of an inner circumferential part of the lid member.

14. The method of claim 2,
wherein the masking member includes:
a cylindrical accommodating member that accommodates the piston inside; and
a ring-shape lid member that is connected to the accommodating member so as to cover one end of the accommodating member in the axial direction, an inner diameter of the lid member being smaller than an inner diameter of the one end,
wherein the first part is comprised of a part of the accommodating member on the one end side, and
wherein the second part is comprised of an inner circumferential part of the lid member.

15. The method of claim 3,
wherein the masking member includes:
a cylindrical accommodating member that accommodates the piston inside; and
a ring-shape lid member that is connected to the accommodating member so as to cover one end of the accommodating member in the axial direction, an inner diameter of the lid member being smaller than an inner diameter of the one end,
wherein the first part is comprised of a part of the accommodating member on the one end side, and
wherein the second part is comprised of an inner circumferential part of the lid member.

16. The method of claim 1, wherein the applying the heat shield material includes applying the heat shield material to the crown surface, while fixing a paint spray gun disposed on the crown surface side of the piston, and moving the piston.

17. The method of claim 2, wherein the applying the heat shield material includes applying the heat shield material to the crown surface, while fixing a paint spray gun disposed on the crown surface side of the piston, and moving the piston.

18. The method of claim 3, wherein the applying the heat shield material includes applying the heat shield material to the crown surface, while fixing a paint spray gun disposed on the crown surface side of the piston, and moving the piston.

19. The method of claim 4, wherein the applying the heat shield material includes applying the heat shield material to the crown surface, while fixing a paint spray gun disposed on the crown surface side of the piston, and moving the piston.

20. The method of claim 5, wherein the applying the heat shield material includes applying the heat shield material to the crown surface, while fixing a paint spray gun disposed on the crown surface side of the piston, and moving the piston.
